(19) United States
(12) Patent Application Publication
(10) Pub. No.: US 2012/0287797 A1
(43) Pub. Date: Nov. 15, 2012

(54) TECHNIQUES FOR MINIMIZING THE BEAM FORMING TIME IN WIRELESS LOCAL AREA NETWORKS

(75) Inventors: Gal Basson, Haifa (IL); Simha Sorin, Zoran (IL); Amichai Sanderovich, Haifa (IL)

(73) Assignee: WILOCITY, LTD., Caesarea (IL)

(21) Appl. No.: 13/106,099

(22) Filed: May 12, 2011

(51) Int. Cl. H04W 24/00; H04W 84/02

(52) U.S. Cl. 370/252; 370/338

(57) ABSTRACT

A method for beamforming in a wireless local area network (WLAN), the method is performed by a receiver wireless station. The method comprises receiving a frame transmitted by a transmitter wireless station over a wireless medium; analyzing a physical (PHY) header of the received frame to determine if a Short Interframe Space (SIFS) response is required; when a SIFS response is required, performing: constructing a response frame including a PHY header, wherein the PHY header includes at least a measured link quality field; inserting a measured signal quality in the measured link quality field; waiting a time equal to a SIFS period; and sending the response frame to the transmitter wireless station after the SIFS period has elapsed, wherein based on received measured values included in response frames the transmitter wireless station predicts a loss link to initiate a beamforming training, thereby reducing the beamforming time.

### TECHNICAL FIELD

The present invention relates generally to beamforming in wireless networks, and particularity to techniques for reducing the beamforming.

### BACKGROUND OF THE INVENTION

The 60 GHz band is an unlicensed band which features a large amount of bandwidth and a large worldwide overlap. The large bandwidth means that a very high volume of information can be transmitted wirelessly. As a result, multiple applications that require transmission of a large amount of data can be developed to allow wireless communication around the 60 GHz band. Examples for such applications include, but are not limited to, wireless high definition TV (HDTV), wireless docking stations, wireless Gigabit Ethernet, and many others. Wireless local area network (WLAN) standards, such as WiGig Alliance (WGA) and IEEE 802.11ad are being developed to serve applications that utilize the 60 GHz spectrum.

Such communication standards enable wireless transmission between two stations that are a short distance from each other. Typically, one station would be a computer device and the other a peripheral device. To enable efficient communication between the wireless stations, the link between the stations should be highly reliable with a minimum downtime.

To further improve wireless communications, transceivers usually perform beamforming (BF). Beamforming is a closed-loop technique that creates a focused antenna beam by shifting a signal in time or in phase to provide gain of the signal in a desired direction and to attenuate the signal in other directions. A beamforming is established after a beamforming training process is completed.

A beamforming training process is a bidirectional sequence of beamforming training frame transmissions that provides the necessary signaling to allow each wireless station to determine appropriate antenna system settings for both transmission and reception antennas. The beamforming training process as suggested by, for example, the WGA communication standard includes two stages: a sector level sweep (SLS) and a beam refinement protocol (BRP). During these stages, the two wireless stations exchange beamforming frames. Specifically, during the SLS stage, the wireless stations exchange information using the beamforming frames to determine their own best transmit sector and/or receive sector. The transmit and receive sectors are in the optimal directions to direct the transmit antenna and the receive antenna respectively.

The BRP stage is a process in which each wireless station trains its receive and transmit antennas to improve their configuration using an iterative procedure. Once the beamforming training process is completed, the two stations select the optimal transmission rate over the established link.

A beamforming time is defined as the time required to determine that a link established between the wireless stations has been lost (or link quality is too low to enable reliable communication), perform the beamforming training, select the optimal transmission rate, and lock on the rate. The major factor that increases the beamforming time is the time elapsed until identifying a lost link. To reach such a determination, the transmitter performs multiple transmission retries if the receiver fails to acknowledge reception of data. The beamforming training process cannot start without a signal that the link has been lost.

Currently, WLAN communication standards, and particularly the WGA standard does not define any mechanism to shorten the beamforming time. Therefore, it would be advantageous to provide a solution to overcome these deficiencies.

### SUMMARY OF THE INVENTION

Certain embodiments disclosed herein include a method for beamforming in a wireless local area network (WLAN) by a receiver wireless station. The method comprises receiving a frame transmitted by a transmitter wireless station over a wireless medium; analyzing a physical (PHY) header of the received frame to determine if a Short Interframe Space (SIFS) response is required; when a SIFS response is required, performing: constructing a response frame including a PHY header, wherein the PHY header includes at least a measured link quality field; inserting a measured signal quality in the measured link quality field; waiting a time equal to a SIFS period; and sending the response frame to the transmitter wireless station after the SIFS period has elapsed, wherein based on received measured values included in response frames the transmitter wireless station predicts a loss link to initiate a beamforming training, thereby reducing the beamforming time.

Certain embodiments disclosed herein also include a wireless station. The wireless station comprises at least one directional antenna for transmitting and receiving signals in a direction set during a beamforming training process; a radio frequency (RF) frontend connected to the at least one directional antenna; a medium access control (MAC) layer module for controlling an access to the wireless medium; a physical (PHY) layer module for performing: analyzing a physical (PHY) header of the received frame to determine if a Short Interframe Space (SIFS) response is required; constructing a response frame including a PHY header, wherein the PHY header includes at least a measured link quality field; inserting a measured signal quality in the measured link quality field; measuring by a timer a time equal to a SIFS period; and providing the response frame to the RF frontend for transmission after the SIFS period has elapsed, wherein based on received measured values included in response frames the transmitter wireless station predicts a loss link to initiate a beamforming training, thereby reducing the beamforming time.

Certain embodiments disclosed herein also include a wireless station capable of generating a data structure adapted for reducing the beamforming time in a wireless local area network (WLAN). The data structure comprises a physical (PHY) header including at least a measured link quality field containing a coded value of a measured signal quality as received at a receiver wireless station and a Short Interframe Space (SIFS) response requirement field indicating if a SIFS response is needed, wherein the PHY header is part of any one of a request frame sent by a transmitter wireless station and a response frame sent by the receiver wireless station, wherein the response frame is sent after a SIFS time period.

### BRIEF DESCRIPTION OF THE DRAWINGS

Various embodiments are particularly pointed out and distinctly claimed in the claims at the conclusion of the specification. The foregoing and other objects, features, and advantages of various embodiments described herein will be apparent from the following detailed description taken in conjunction with the accompanying drawings.

FIG. 1 is a diagram utilized to describe the techniques for reducing the beamforming time according to certain embodiments of the invention;

FIG. 2 is a diagram illustrating the concept of a response frame;

FIGS. 3A and 3B are schematic diagrams of a frame and a PHY header constructed in accordance with an embodiment of the invention.

FIG. 4 is a flow diagram illustrating certain embodiments of the invention.

FIG. 5 is a flowchart describing a method for determining if a beamforming training process should be initiated in accordance with an embodiment of the invention.

FIG. 6 is a block diagram of a wireless station constructed according to an embodiment of the invention.

### DETAILED DESCRIPTION OF THE INVENTION

The embodiments disclosed are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

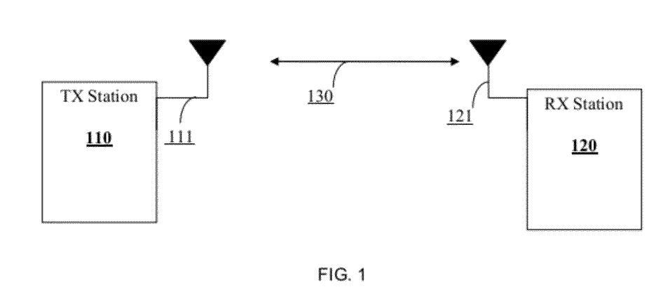

FIG. 1 is an exemplary diagram utilized to describe the techniques for reducing the beamforming time according to certain embodiments of the invention. Shown in FIG. 1 is a first wireless station 110 and a second wireless station 120 communicating over a wireless medium. Each of the wireless stations 110 and 120 includes a directional antenna 111 and 121 capable of performing a beamforming process, for example, as described in detail above. Between the wireless stations 110 and 120, there is established a bi-directional link 130. The link 130 is established after completion of the beamforming process described in detail above. In an embodiment of the invention, the bi-directional link 130 facilitates a wireless PCI express bus, enabling wireless communication between the wireless stations 110 and 120 according to the PCI express bus standard. In another embodiment, the communication over the link 130 complies with the wireless communication protocols including, but not limited to, the WiGig Alliance (WGA). The bi-directional link facilitates a wireless communication over a 60 GHz frequency band.

For the sake of brevity and without limiting the scope of the invention, only two wireless stations are illustrated in FIG. 1. Further, the station 110 will be referred to hereinafter as a transmitter (TX) station, and the wireless station 120 as a receiver (RX) station. According to certain embodiments of the invention, the TX station 110 transmits two types of data frames to the RX station 120: 1) frames that require response, and 2) frames that do not require response.

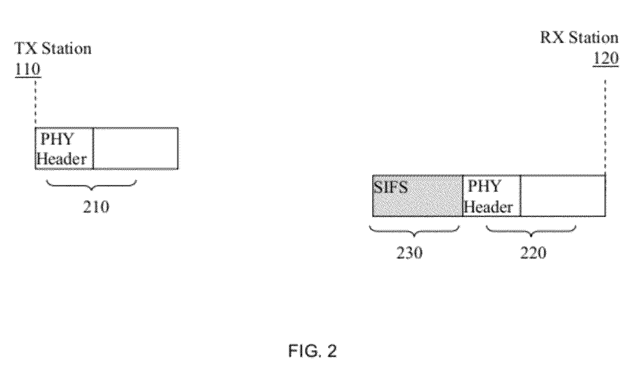

For example, as illustrated in FIG. 2, a frame 210 is transmitted by the TX station 110 to the RX station 120 and includes, as part of the PHY header (not shown in FIG. 2) of the frame 210, a field indicating if a Short Interframe Space (SIFS) response is required or not. A SIFS response is a response frame 220 sent by the RX station 120 after a SIFS period 230. The duration of the SIFS period is predefined and in exemplary embodiments is 3 microseconds. Typically, the response frame 220 can be any one of an ACK frame, a block ACK frame, or any other type of frame acknowledging reception of the data sent from the TX station 110. The time of the SIFS period 230 is the time from the end of the last symbols (when OFDM symbols construct the frame) of the signal of a previous frame, to the beginning of the first symbol of the preamble of the subsequent frame as seen at the air interface.

In accordance with an embodiment of the invention, when the RX station 120 transmits the response frame 220 following the SIFS period 230, the response frame 220 includes at least one link quality measurement, such as a received signal strength indicator (RSSI) measurement of the power present in the received frame 210 at the RX station 120. The RSSI is measured by the station in dBm or mW, but when sent to the TX station 110, the measured value is encoded into a numerical representation, as such an unsigned integer, and a hexadecima is sent back to the TX station 110. In an embodiment of the invention, the encoding of the measured RSSI value includes: measured RF energy greater than −36 dBm which is represented as 15. A measured RF energy less than or equal to −66 dBm is represented as 1. The value 0 is reserved to indicate that the RSSI value is included in the response frame 220. Other link quality measurements include a signal-to-noise ratio (SNR), an error rate, and the like.

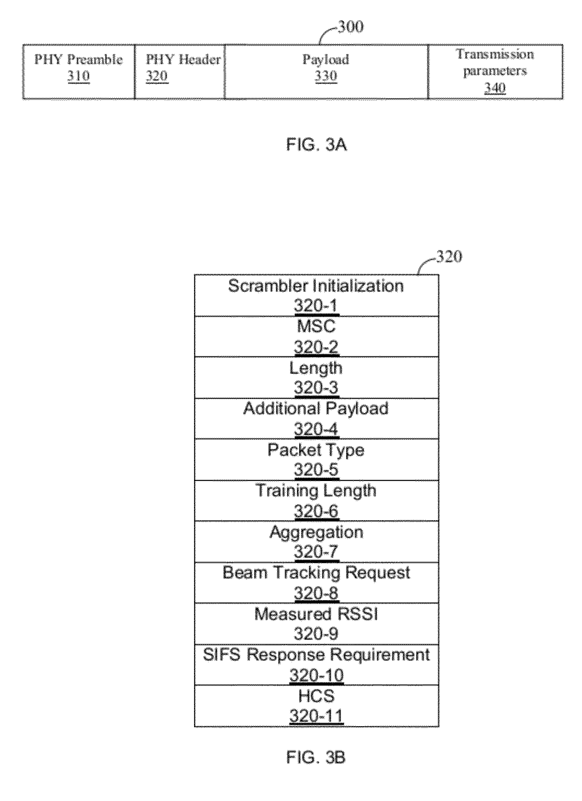

The request for SIFS response and the return RSSI value are realized by a modified Physical (PHY) layer header constructed according to an embodiment of the invention, and further illustrated in FIG. 3A and FIG. 3B. A frame 300, illustrated in FIG. 3A, typically includes a preamble 310, a physical (PHY) header 320, a payload portion 330, and a PHY transmission parameter field 340 including, for example, automatic gain control (AGC). The preamble 310 typically consists of a short training (STF) field and a channel estimation field (CE). The payload portion 330 typically consists of aggregation of data blocks. The frame 300 may be either a request frame 210 (sent by the TX station 110) or a response frame 220 (sent by the RX station 120).

In accordance with the teachings of the invention, the PHY header 320 is constructed to include the fields shown in detail in FIG. 3B: a scrambler initialization field 320-1, a MSC field 320-2, a length field 320-3 indicating the length of the frame 300, additional payload 320-4 indicating if the current frame is followed by a frame that includes additional payload, a packet type field 320-5 indicating the training packet type, a training length field 320-6 defining the length of the STF in the preamble 310, an aggregation field 320-7 indicating the payload 320 including aggregation of packets, a beam tracking request 320-8 set to ‘1’ when a beam tracking is required, a measured RSSI field 320-9, a SIFS response requirement field 320-10, and a header check sequence (HCS) field 320-11 for error corrections and detection in the PHY header 320.

The PHY header 320 has been purposely modified to include the measured RSSI field 320-9 and a SIFS response requirement field 320-10 to enable minimizing the beamforming time. As mentioned above, the SIFS response requirement field 320-10 indicates whether or not the transmitted frame requires a SIFS response within a SIFS time, by setting a single bit in this field to a respective value (e.g., a logic value ‘1’ requires SIFS response and a ‘0’ does not). The measured RSSI field 320-9, when transmitted in a response frame, contains a coded value representing the measured radio power of the last received frame. In an exemplary embodiment, the RSSI value included in this field is an unsigned integer coded as follows: a value of 15 represents a power greater than or equal to −39 dBm; a value of 1 represents a power less than or equal to −65 dBm, and values of 2-14 represent power levels of between −35 dBm and −65 dBm. A value of 0 indicates that particular frame is not a response frame, i.e., does not follow a SIFS period prior to current transmission. It should be appreciated that measured RSSI can be coded in other representations, and such coding is not limited to the example provided herein.

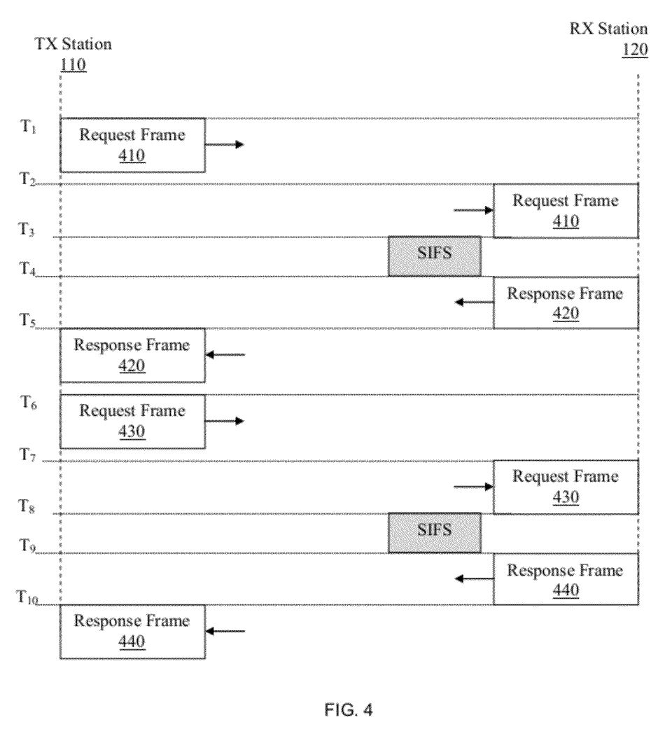

FIG. 4 provides a non-limiting example for utilizing the PHY header 320 to reduce the beamforming time according to an embodiment of the invention. As discussed above, the beamforming time in WPANs and/or WLANs facilitating, for example, a communication protocol as defined in WGA standard, is defined as the time that it takes to complete the following: a) identify a lost link; b) completion of beamforming training; c) selection of an optimal transmission rate by the two wireless stations; d) and locking on the selected rate. The time for identifying a lost link is the longer period in the process. For example, if a typical beamforming time is 1.2 msec, the time for identifying a lost link using conventional techniques is 0.8 msec.

According to certain principles of the invention, by measuring the RSSI of the RX station 120 and communicating the measures back to the TX station 110, the TX station 110 can determine the signal quality on the link 130, and based on such determination predict that the link is about to become lost. As a result, the TX station 110 can initiate the beamforming training process beforehand, thereby reducing the total time of the training process.

As shown in FIG. 4, at T1, a request frame 410 is sent from the TX station 110 to the RX station 120. The request frame 410 includes the PHY header 320, where the SIFS response requirement field 320-10 (see FIG. 3B) is set to a value that indicates that such response is needed. At T2, upon reception of the request frame 410, the RX station 120, checks the value of the field 320-10 in the PHY header 320, and if a SIFS response is needed, the station measures the RF power of the received signal, i.e., the RSSI. Thereafter, the RX station 120 converts the measured RSSI to, for example, an unsigned value as described above. In addition, a response frame 420 is constructed to include at least the PHY header 320 where the converted RSSI value is set in the measured RSSI field 320-9. Prior to sending the frame 420, the RX station waits a SIFS time period, between T3 and T4. The SIFS time period is predetermined.

At T4, the response frame 420 is sent to the TX station 110, which upon reception of the packet, at T5, extracts the measured RSSI values and locally saves this information in a memory (not shown). The flow described above is repeated at between T6 and T10, during which the RX station 120 measures the RSSI value of an additional request frame 430 and returns the measured RSSI value in a response frame 440. Thus, the TX station 110 logs the RSSI values of two frames. For example, the measured RSSI values in frames 420 and 440 are respectively −40 dBm and −60 dBm (for the sake of brevity, coded RSSI values are not mentioned). Then, the TX station 110 analyzes the logged measures and determines if the beamforming training process should be initiated, due to a predicted link loss or degradation of the link quality. For example, based on the above measures, it can be derived that the link suffers from degradation in the power of received signals, thus the probability for a state of link loss is higher. Therefore, in such case the TX station 110 starts the beamforming training process.

It should be noted that the decision to initiate beamforming training may be performed regardless of acknowledgment of received frames. That is, the response frame 420 and 440 may acknowledge the reception of data, but still beamforming training process may be started, as the TX station 110 determines that the link is about to fail. It should be further noted that the determination may be performed using any number of RSSI values. In an embodiment of the invention, the TX station 110 may base the decision to trigger the beamforming training process on RSSI measures received from one or more RX stations communicating with the TX station 110.

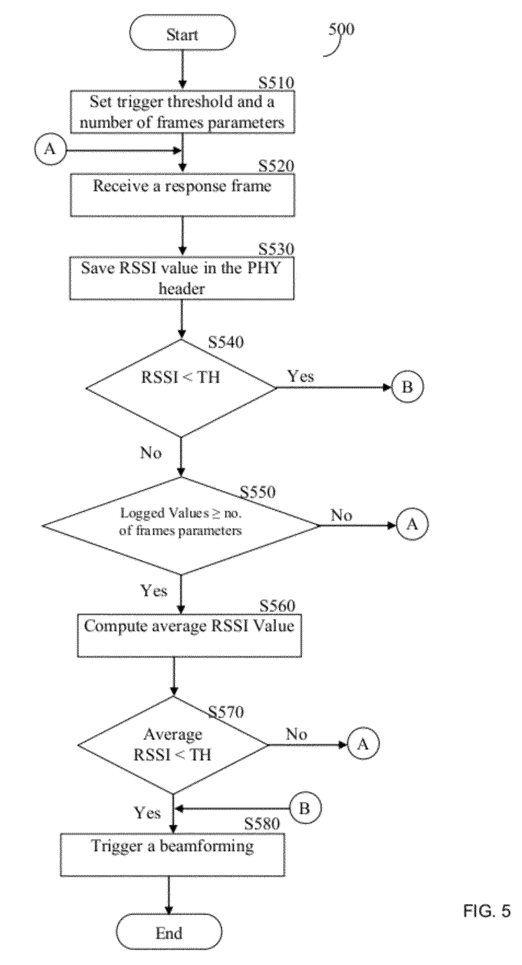

FIG. 5 shows an exemplary and non-limiting flowchart 500 illustrating a method for determining if a beamforming training process should be initiated in accordance with an embodiment of the invention. At S510, a trigger threshold and a number of frames parameters are set to their predefined values. The number of frames is a number of subsequent response frames that include a measured RSSI value. The trigger threshold is set to a value that any RSSI value below the threshold indicates, in high probability, that the link is experiencing degradation in the quality of the link, thus beamforming training should be initiated.

At S520, a response frame is received at the TX station 110, and then, at S530, the RSSI value (in the PHY Header of the received frame) value is extracted and saved in a memory (not shown). It should be noted that RSSI values set to ‘0’ are not saved, as such values indicate that no RSSI measurement was performed. At S540, it is determined if the extracted RSSI value is less than the trigger threshold's value, and if so execution continues with S580, where the beamforming training process is initiated; otherwise, execution continues with S550.

At S550, it is checked if the number of subsequent RSSI values saved in the memory is equal or greater than a value set for the number of frames parameter. If so, execution continues with S560, where an average of an RSSI value over a number of values equal to the number of frames parameter value is computed. For example, if this parameter is set to 4, then the average of the last 4 subsequent RSSI values is computed. It should be noted that other statistical methods can be used to determinate deviation for a normal RSSI value. If S550 results with a negative answer, execution returns to S520.

At S570, it is checked if the computed average is below the triggered threshold's value, and if so execution continues with S580 where a beamforming training process is initiated by the TX station; otherwise, execution returns to S520.

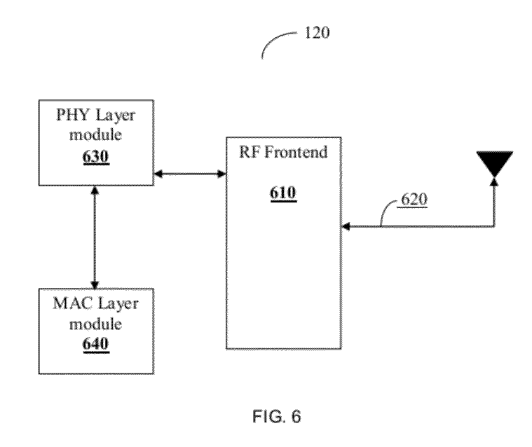

FIG. 6 shows an exemplary and non-limiting block diagram of an RX station 120 according to an embodiment of the invention. The RX station 120 includes a radio frequency (RF) frontend 610 connected to a directional antenna 620. The RF frontend 610 can set the directional antenna 620 to a direction/sector determined during the beamforming process.

The RX station 120 also includes a physical (PHY) layer module 630 and a MAC layer module 640. The PHY layer module 630, in addition to performing typical PHY layer operations for interfacing with a wireless medium, analyzes the PHY header (e.g., PHY header 320) to determine if the SIFS response is required, and if so measures the power of a received radio signal. The PHY layer module 630 generates a response frame including the PHY header as described in detail with reference to FIGS. 3A and 3B. In addition, the PHY layer module 630 includes a SIFS timer (not shown) to time the SIFS period prior to transmission of the response frames. The MAC layer module 640 performs MAC layer operations compatible with communication standards of WLANs operable over the 60 GHz spectrum.

In another embodiment, the RX station can log measured RSSI values and compute average of the RSSI values to predict a lost link. Then, the RX station, upon determination of a lost link, sends a link lost indication to the TX station. The TX station upon reception of this indication triggers the beamforming training process.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

The principles of various embodiments of the invention can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analogy circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What is claimed is:

1. A method for beamforming in a wireless local area network (WLAN), the method is performed by a receiver wireless station, comprising:
receiving a frame transmitted by a transmitter wireless station over a wireless medium;
analyzing a physical (PHY) header of the received frame to determine if a Short Interframe Space (SIFS) response is required;
when a SIFS response is required, performing:
constructing a response frame including a PHY header, wherein the PHY header includes at least a measured link quality field;
inserting a measured signal quality in the measured link quality field;
waiting a time equals to a SIFS period; and
sending the response frame to the transmitter wireless station after the SIFS period has elapsed, wherein based on received measured values included in response frames the transmitter wireless station predicts a loss link to initiate a beamforming training, thereby reducing the beamforming time.

2. The method of claim 1, wherein the PHY header further comprises a SIFS response requirement field.

3. The method of claim 2, wherein determination if the SIFS response is required is based on the value of the response requirement field set by the transmitter wireless system.

4. The method of claim 1, further comprising:
measuring, at the receiver wireless station, the quality of the received signal quality, wherein the measured signal quality is a received signal strength indicator (RSSI) measurement of a power the signal.

5. The method of claim 1, further comprising:
measuring, at the receiver wireless station, the quality of the received signal quality, wherein the measured signal quality is a signal-to-noise ratio (SNR).

6. The method of claim 4, wherein inserting the measured signal quality in the measured link quality field further comprising: inserting a coded value of the measured signal quality.

7. The method of claim 1, wherein the beamforming time is a time required for completing the following: a) identify a lost link between the transmitter and receiver wireless stations; b) completing of a beamforming training process; c) selecting of an optimal transmission rate by the receiver and transmitter wireless stations; d) and locking on the selected rate.

8. The method of claim 7, further comprising:
by the transmitter wireless station performing:
extracting the measured signal quality value from the measured link quality field included in the PHY header of a received response frame;
logging the extracted value of the measured signal quality;
computing an average of the measured signal quality over a number of predefined logged values; and
comparing the computed average value to a threshold; and
initiating the beamforming training process if the computed average is below the threshold, wherein the threshold defines a low limit for the signal quality indicating that a link is about to became lost.

9. The method of claim 1, wherein at the end of the beamforming time a bi-directional link is established between the receiver wireless station and the transmitter wireless station.

10. The method of claim 9, wherein the bi-directional link facilitates a wireless communication over a 60 GHz frequency band.

11. A non-transitory computer readable medium having stored thereon instructions for causing one or more processing units to execute the method according to claim 1.

12. A wireless station comprising:
at least one directional antenna for transmitting and receiving signals in a direction set during a beamforming training process;
a radio frequency (RF) frontend connected to the at least one directional antenna;
a medium access control (MAC) layer module for controlling an access to the wireless medium;
a physical (PHY) layer module for performing:
analyzing a physical (PHY) header of the received frame to determine if a Short Interframe Space (SIFS) response is required;
constructing a response frame including a PHY header, wherein the PHY header includes at least a measured link quality field;
inserting a measured signal quality in the measured link quality field;
measuring by a timer a time equals to a SIFS period; and
providing the response frame to the RF frontend for transmission after the SIFS period has elapsed, wherein based on received measured values included in response frames the transmitter wireless station predicts a loss link to initiate a beamforming training, thereby reducing the beamforming time.

13. The wireless station of claim 12, wherein the PHY header further comprises a SIFS response requirement field.

14. The wireless station of claim 13, wherein determination if the SIFS response is required is based on the value of the response requirement field set by the transmitter wireless system.

15. The wireless station of claim 12, wherein the PHY layer module further measures the quality of the received signal quality, wherein the measured signal quality is any one of: a received signal strength indicator (RSSI) and a signal-to-noise ratio (SNR).

16. The wireless station of claim 15, wherein inserting the measured signal quality in the measured link quality field further comprising: inserting a coded value of the measured signal quality.

17. The wireless station of claim 12, wherein the beamforming time is a time required for completing the following: a) identify a lost link; b) completing of a beamforming training process; c) selecting of an optimal transmission rate by the receiver and transmitter wireless stations; d) and locking on the selected rate.

18. A method adapted for reducing a beamforming time in a wireless local area network (WLAN), the method is performed by a transmitter wireless station, comprising:
receiving a response frame including at least a physical (PHY) header, wherein the PHY header includes at least a measured link quality field containing a coded value of a link quality as measured by a receiver wireless station;
extracting the measured signal quality value from the measured link quality field;
logging the extracted value of the measured signal quality;
computing an average of the measured signal quality over a number of predefined logged values;
comparing the computed average value to a threshold; and
initiating a beamforming training process if the computed average is below the threshold, wherein the threshold defines a low limit for the signal quality indicating that a link is about to became lost.

19. The method of claim 18, wherein the beamforming time is a time required for completing the following: a) identify a lost link between the receiver and transmitter wireless stations; b) completing of the beamforming training process; c) selecting of an optimal transmission rate by the receiver and transmitter wireless stations; d) and locking on the selected rate.

20. The method of claim 19, wherein predicting beforehand a lost link enables an early start of the beamforming training process, thereby reducing the beamforming time.

21. A wireless station capable of generating a data structure adapted for reducing the beamforming time in a wireless local area network (WLAN), the data structure comprising:
a physical (PHY) header including at least a measured link quality field containing a coded value of a measured signal quality as received at a receiver wireless station and a Short Interframe Space (SIFS) response requirement field indicating if a SIFS response is needed, wherein the PHY header is part of any one of a request frame sent by a transmitter wireless station and a response frame sent by the receiver wireless station, wherein the response frame is sent after a SIFS time period.
